(19) United States
(12) Patent Application Publication
(10) Pub. No.: US 2013/0316049 A1
(43) Pub. Date: Nov. 28, 2013

(54) Galactofructose for its regulating effect on intestinal transit

(71) Applicants: Pascal RONFARD, Paris (FR); Guillaume BAXTER, Brussels (BE)

(72) Inventors: Pascal RONFARD, Paris (FR); Guillaume BAXTER, Brussels (BE)

(73) Assignee: SOLVAY SA, Brussels (BE)

(21) Appl. No.: 13/959,116

(22) Filed: Aug. 5, 2013

Related U.S. Application Data
(63) Continuation of application No. PCT/EP2012/052068, filed on Feb. 7, 2012.

(30) Foreign Application Priority Data
Feb. 8, 2011 (FR) 11.51001

(51) Int. Cl. A23L 1/29

(52) U.S. Cl. CPC A23L 1/293
USPC 426/71

(57) ABSTRACT

Galactofructose for its regulating effect on the intestinal transit time of mammals, when it is incorporated into a food composition and when said composition is absorbed by the mammal in an amount corresponding to daily doses of galactofructose, averaged over 30 days, of between 0.1 and 2 g.

### CROSS-REFERENCE TO RELATED APPLICATIONS

This application is a continuation of International Application no. PCT/EP2012/052068 filed Feb. 7, 2012, which claims priority to French application No. 11.51001 filed on Feb. 8, 2011, the whole content of these applications being incorporated herein by reference for all purposes.

### TECHNICAL FIELD

The invention relates to the effect of oligosaccharides on intestinal transit in mammals.

The term “intestinal transit” is intended to mean the complex operation performed by the intestines in order to transport the food bolus from the stomach to the rectum.

### BACKGROUND OF THE INVENTION

Currently, an increasing number of human beings are suffering from health problems linked to intestinal transit dysregulation. Intestinal transit dysregulation can result both in transit times which are too long (hypotransit) and transit times which are too short (hypertransit).

Health problems resulting from intestinal transit dysregulation can vary from simple intestinal bloating to acute pain (hypotransit). In the case of intestinal transit which is too fast, dehydration may even occur. In certain regions of the world it is a major public health problem, which especially involves children and is one of the most common causes of infant mortality.

In the most developed regions of the world, intestinal transit dysregulation is worsened by a sedentary lifestyle, food which is too low in fiber and by stress.

The effect of certain oligosaccharides on intestinal transit is known. Galactofructose is in fact commonly used to accelerate intestinal transit. However, this can result in the conversion of intestinal hypotransit into intestinal hypertransit (“laxative” effect).

FR 2 891 439 describes a food supplement comprising an agent for increasing the weight of feces and a laxative. The laxative is preferably in particular lactulose.

However, the food supplement in FR 2 891 439 is intended for patients suffering from constipation, or even from advanced stages of constipation.

### SUMMARY

The invention aims to improve the well-being of generally healthy mammals, through acting on their intestinal flora.

Consequently, the invention relates to galactofructose for its regulating effect on the intestinal transit time of mammals, when it is incorporated into a food composition and when said composition is absorbed by the mammal in an amount corresponding to daily doses of galactofructose, averaged over 30 consecutive days, of between 0.1 and 5 g, advantageously between 0.1 and 2 g.

### DETAILED DESCRIPTION

As those skilled in the art will easily understand, the term “to average” should be understood here in its mathematical sense, and therefore means “to calculate the average” (ref : http://en.wiktionary.org/wiki/moyenner). Quite obviously, the average to be calculated in order to define the dosage in accordance with the invention is the arithmetic average of the daily doses absorbed during the period of 30 days.

In the invention, the mammal is preferably healthy, showing no sign of disease.

Galactofructose, also called lactulose, is a disaccharide formed from the combination of two monosaccharide molecules, fructose and galactose. Its chemical formula is (4-O-β-D-Galactopyranosyl-β-D-fructofuranose). It is an isomerization product of lactose, which both have the same empirical formula (C₁₂H₂₂O₁₁) and molecular weight (342.3).

Galactofructose, when it is absorbed in small amounts according to the invention in food compositions, improves the well-being of mammals. The invention also has the advantage of not interfering with the taste and the appearance (for example color) of the food compositions. This is particularly advantageous for feeding infants and animals, in which a change in taste may cause rejection of the foodstuff.

It is recommended that the galactofructose according to the invention comprise less than 30%, preferably less than 25% by total weight of sugars such as fructose, epilactose, galactose or lactose relative to the amount of galactofructose. The galactofructose according to the invention is incorporated into a food composition. The expression “food composition” is understood to mean a composition intended for feeding mammals. The mammals are preferably human beings, although the invention can also be used for improving the well-being of various mammalian animals, such as domestic animals. The food composition is advantageously a composition absorbed regularly, preferably at least once a month, more preferentially once a week, and particularly preferentially daily. Food compositions for human beings, such as bread, butter, milk, fermented dairy products, cereals, biscuits, beverages and fruit juices are advantageous.

In one particularly preferred embodiment of the invention, the food compositions are intended for feeding children.

According to the invention, the galactofructose is absorbed in daily amounts, averaged over 30 consecutive days, of between 0.1 and 5 g, advantageously between 0.1 and 2 g. This means that the daily doses may vary but that the total dose absorbed over one month divided by 30 is between 0.1 and 5 g, advantageously 2 5 between 0.1 and 2 g.

In another embodiment of the invention, the amounts are averaged over 7 days, which means that the total dose absorbed over seven consecutive days divided by 7 is between 0.1 and 5 g, advantageously between 0.1 and 2 g.

In one advantageous embodiment of the invention, the daily dose absorbed, not averaged, exceeds 0.1 g, preferably 0.5 g. It is recommended, furthermore, that it remain less than 5 g and in certain cases less than 2 g.

In one preferred variant, the daily doses of galactofructose are between 0.1 and 5 g, advantageously between 0.5 and 2 g, for at least 30 consecutive days. In this variant, galactofructose is absorbed regularly every day and the doses are no longer averages, but daily estimated values.

The regulating effect on intestinal transit time according to the invention is measured concretely by scintigraphy, the patient absorbing a radioactive tracer.

It has been observed that the regular taking, according to the invention, of galactofructose in low doses makes it possible not only to accelerate intestinal transit when it is too slow, but also, surprisingly, to slow it down when it is too fast, in particular when it is slightly too fast. In the invention, the regulating effect on intestinal transit time is such that the intestinal transit time, measured by scintigraphy, is regulated at values generally less than 40 hours, often less than 35 hours and in certain advantageous cases less than 30 hours. These values are also generally greater than 10 hours, often greater than 15 hours, and in certain cases greater than 20 hours.

In a first embodiment of the invention, galactofructose used for its regulating effect on the intestinal transit time of mammals is done so in order to accelerate intestinal transit in the mammals which absorb it (these mammals typically having an intestinal transit which is too slow before beginning the absorption). Therefore, a mammal whose intestinal transit is too slow before having absorbed galactofructose sees its intestinal transit time, measured by scintigraphy, reduced from a given initial value (value before absorption) to a lower value, which lower value is less than 40 hours, often less than 35 hours and in certain advantageous cases less than 30 hours, after it has absorbed galactofructose incorporated into a food composition according to the dosage in accordance with the present invention; the value after absorption in accordance with the present invention is, moreover, generally greater than 10 hours, often greater than 15 hours and in certain advantageous cases greater than 20 hours.

According to this first embodiment of the invention, the initial value (before absorption) of the intestinal transit time may be, for example, at a value in a range from 40 to 50 hours, in a range from 35 to 45 hours or else in a range from 30 to 40 hours. According to this first embodiment of the invention, the reduction in the intestinal transit time (value before absorption minus value after use in accordance with the invention) is advantageously at least 2 hours, preferably at least 5 hours; it may be at least 10 hours, or even at least 15 hours.

In one particularly advantageous variant of this first embodiment, the mammal whose intestinal transit is too slow before having absorbed galactofructose is nevertheless not suffering from constipation (the intestinal transit thereof is only slightly too slow), and said mammal is even advantageously healthy, showing no sign of disease. The constipation may be characterized by an intestinal transit time, measured by scintigraphy, of at least 48 hours, for example. According to this variant of the first embodiment of the invention, the initial value (before absorption) of the intestinal transit time of the mammal whose intestinal transit is too slow before having absorbed galactofructose is preferably equal to at most 40 hours; furthermore, this mammal sees its intestinal transit time reduced to a value of generally less than 35 hours, preferably less than 30 hours, after it has absorbed galactofructose incorporated into a food composition according to the dosage in accordance with the present invention. According to this variant of the first embodiment of the invention, the initial value (before absorption) of the intestinal transit time of the mammal whose intestinal transit is too slow before having absorbed galactofructose is particularly preferably from 30 to 40 hours; furthermore, this mammal sees its intestinal transit time reduced, so as to reach a value of generally less than 30 hours, preferably to a value between 20 and 30 hours, after it has absorbed galactofructose incorporated into a food composition according to the dosage in accordance with the present invention.

In a second, particularly surprising, embodiment of the invention, galactofructose used for its regulating effect on the intestinal transit time of mammals is done so in order to slow down intestinal transit in the mammals which absorb it (these mammals typically having an intestinal transit which is too fast before beginning the absorption). Therefore, a mammal whose intestinal transit is too fast before having absorbed galactofructose sees its intestinal transit time, measured by scintigraphy, increased from a given initial value (before absorption) to a higher value, which higher value is generally greater than 10 hours, often greater than 15 hours and in certain advantageous cases greater than 20 hours, after it has absorbed galactofructose incorporated into a food composition according to the dosage in accordance with the present invention; the value after absorption in accordance with the present invention is, moreover, generally less than 40 hours, often less than 35 hours and in certain advantageous cases less than 30 hours. According to this second embodiment of the invention, the initial value (before absorption) of the intestinal transit time may be, for example, at a value included in a range from 0 to 10 hours, in a range from 5 to 15 hours or else in a range from 10 to 20 hours. According to this second embodiment of the invention, the increase in the intestinal transit time (value after use in accordance with the invention minus value before absorption) is advantageously at least 2 hours, preferably at least 5 hours; it may be at least 10 hours, or even at least 15 hours.

In one particularly advantageous variant of this second embodiment, the mammal whose intestinal transit is too fast before having absorbed galactofructose is nevertheless not suffering from diarrhea (the intestinal transit thereof is only slightly too fast), and said mammal is even advantageously healthy, showing no sign of disease. The diarrhea may be characterized by an intestinal transit time, measured by scintigraphy, of at most 8 hours, for example. According to this variant of the second embodiment of the invention, the initial value (before absorption) of the intestinal transit time of the mammal whose intestinal transit is too fast before having absorbed galactofructose is preferably equal to at least 10 hours; furthermore, this mammal sees its intestinal transit time increased, so as to reach a value of generally greater than 15 hours, preferably greater than 20 hours, after it has absorbed galactofructose incorporated into a food composition according to the dosage in accordance with the present invention. According to this variant of the second embodiment of the invention, the initial value (before absorption) of the intestinal transit time of the mammal whose intestinal transit is too fast before having absorbed galactofructose is particularly preferably a value included in a range from 10 to 20 hours; furthermore, this mammal sees its intestinal transit time increased, so as to reach a value of generally greater than 20 hours, preferably a value between 20 and 30 hours, after it has absorbed galactofructose incorporated into a food composition according to the dosage in accordance with the present invention.

In the invention, the daily number of stools is generally between 0.5 and 1.5, for a standardized unit stool weight value of 220 g/day.

The invention also relates to galactofructose for its regulating effect on the intestinal transit time of mammals, combined with its prebiotic effect on the intestinal flora, when it is incorporated into a food composition and when said composition is absorbed by the mammal in an amount corresponding to daily doses of galactofructose, averaged over 30 days, of between 0.1 and 5 g, advantageously between 0.1 and 2 g.

A prebiotic is a non-digestible food compound that can be broken down by the microorganisms of the intestinal flora. This breakdown gives rise to an effect on the intestinal flora of the mammal, beneficial to the health thereof since it leads to development of certain bacteria of the flora. Among these, bifidobacteria are known for having an important role, for example in the immune system of the hosts. Their selective development by virtue of prebiotic compounds (bifidogenic prebiotic effect) is therefore beneficial to the well-being of the host mammal. Therefore, the prebiotic effect of a non-living compound refers to the change, both in composition and in activity, of the intestinal flora of the host due to the ingestion of this compound, when this change has a beneficial effect on the well-being and/or the health of the host (see: Gibson and Roberfroid, J. Nutr, 125, 1401, 1995).

In the combined effect according to the invention, an increase in the population of bifidobacteria in the intestinal flora of the host mammal is also observed, in addition to the regulating effect on the intestinal transit. This increase is at least 50%. Preferably, the population is at least doubled. Particularly preferably, the population of Bifidobacterium spp bifidobacteria, expressed in log 10, is increased by 0.5 at least, which corresponds to a multiplication of the population by a factor of around 3 at least. Bifidobacterium spp bifidobacteria protect the gut against colonization by pathogenic bacteria. This protection results, on the one hand, from the competition at the surface of the cells, from the competition for essential nutrients, from the production of antimicrobial agents and from the production of compounds comprising short-chain fatty acids, which decrease the pH of the feces and inhibit the development of pathogenic bacteria. Bifidobacterium spp bifidobacteria are also associated with a strengthening of the immune system, especially in children, and with a preventive action against cancer, via a reduction in the activity of enzymes that convert procarcinogenic substances into carcinogenic substances (see von Wright et al., Eur J. Gastroenterol.Hepatol. November 1999, 11(11), pp1195-1198).

Owing to the combined effect according to the invention, the increase in the population of bifidobacteria does not require any probiotic in the food composition. 2 0 It is even recommended that the composition be substantially free thereof. The expression “substantially free of probiotics” is understood to mean that the food composition alone, in the absence of galactofructose, gives rise to an increase in the population of Bifidobacterium spp of less than 10%, generally of less than 5%.

The invention is preferably aimed at mammals in good health, exhibiting no sign of disease. It makes it possible to improve their well-being. Under certain circumstances, it also makes it possible to protect their good health.

In the same way as for the galactofructose according to the invention, the food composition according to the invention is advantageously a regularly absorbed composition, and preferably is intended for feeding children, such as powdered milk for feeding infants.

In one preferred embodiment variant of the food composition according to the invention, this is also substantially free of probiotics.

The invention also relates to a prepackaged dose of the composition according to one of the preceding claims, comprising between 0.1 and 2 grams, advantageously between 0.1 and 1 g of galactofructose. It is recommended to absorb at least one such dose daily.

The invention finally relates to a process for manufacturing a composition according to the invention, according to which a galactofructose powder, having a water content of less than 5% by weight and an average particle size D50 of less than 500 μm, is mixed with a foodstuff. The powder may be manufactured according to the process described in FR2898516.

The process according to the invention is particularly advantageous when the foodstuff is itself in powder form, as is the case of milk powders for feeding children, for example.

The following examples serve to illustrate the invention.

### EXAMPLES

### Example 1

20 human volunteers, aged from 18 to 50 years old, having a body mass index of between 20 and 30, were randomly split into two groups of 10, one group absorbing, every day, for 30 days, a 20 cl glass of milk produced from powdered milk to which 2.5 g of Solactis® powder are added, corresponding to 1.5 g of galactofructose, and the other group absorbing a placebo. The galactofructose powder has the following composition, as percentage relative to the galactofructose content:

| Tagatose | Fructose | Galactose | Epilactose | Lactose |
|---|---|---|---|---|
| <2% | <1% | <14% | <6% | <8% |

The volunteers did not display any sign of disease, in particular of intestinal disease. They had never participated in a test relating to prebiotics or probiotics. During the test they did not absorb any probiotic. The Bifidobacterium spp population before the test, measured by the FISH (Fluorescence In Situ Hybridization) technique was around 8.5 log 10 cells/g feces on average. The initial intestinal transit time measured by scintigraphy was 52 h in the two groups. At the end of the test (30 days), the Bifidobacterium spp population increased to around 9 log 10 in the group absorbing galactofructose according to the invention and the transit time decreased to 22 h. No significant variation (taking into account natural variations in measurement), both in Bifidobacterium spp and in transit time, was observed in the placebo group. 30 days after the end of the ingestion, the bifidobacterium population of the galactofructose group returned to a value close to 8.75 on average. Furthermore, it was verified that the total population of anaerobic bacteria varied little during and after the test, both in the galactofructose group and in the placebo group.

### Example 2

20 human volunteers, aged from 18 to 50 years old, having a body mass index of between 20 and 30, were randomly split into two groups of 10, one group absorbing, every day, for 30 days, a 20 cl glass of milk produced from powdered milk to which 2.5 g of Solactis® powder are added, corresponding to 1.5 g of galactofructose, and the other group absorbing a placebo. The galactofructose powder has the following composition, as percentage relative to the galactofructose content:

| Tagatose | Fructose | Galactose | Epilactose | Lactose |
|---|---|---|---|---|
| <2% | <1% | <14% | <6% | <8% |

The volunteers did not display any sign of disease, in particular of intestinal disease. They had never participated in a test relating to prebiotics or probiotics. During the test they did not absorb any probiotic. The initial intestinal transit time measured by scintigraphy was 14 h in the two groups. At the end of the test (30 days), the transit time was 24 h in the group absorbing galactofructose according to the invention. On the other hand, no significant variation (taking into account natural variations in measurement) in transit time was observed in the placebo group.

### Example 3

20 children were randomly split into two groups of 10, one group absorbing, every day, for 30 days, a glass of milk produced from powdered milk to which Solactis® powder is added, corresponding to l g of galactofructose, and the other group absorbing a placebo. The galactofructose powder has the following composition, as percentage relative to the galactofructose content:

| Tagatose | Fructose | Galactose | Epilactose | Lactose |
|---|---|---|---|---|
| <2% | <1% | <14% | <6% | <8% |

The children did not display any sign of disease, in particular of intestinal disease. They had never participated in a test relating to prebiotics or probiotics. During the test they did not absorb any probiotic. The initial intestinal transit time measured by scintigraphy was 34 h in the two groups. In the group absorbing galactofructose according to the invention, the transit time measured was 21 h halfway through the test (15 days) and was 24 h at the end of the test (30 days). On the other hand, no significant variation (taking into account natural variations in measurement) in transit time was observed in the placebo group.

1. A method for regulating the intestinal transit time of a mammal in need thereof, said method comprising using a food composition which incorporates galactofructose and which is absorbed by the mammal in an amount corresponding to daily doses of galactofructose, averaged over 30 consecutive days, of between 0.1 and 5 g.

2. A method for slowing down the intestinal transit of a mammal in need thereof, said method comprising using galactofructose incorporated into a food composition which is absorbed by the mammal in an amount corresponding to daily doses of galactofructose, averaged over 30 consecutive days, of between 0.1 and 5 g.

3. The method according to claim 2, wherein the mammal is not suffering from diarrhea.

4. The method according to claim 3, wherein the mammal is healthy.

5. The method according to claim 2, wherein the mammal has an intestinal transit time before absorption, measured by scintigraphy, equal to an initial value ranging from 10 to 20 hours.

6. The method according to claim 5, wherein said intestinal transit time, measured by scintigraphy, is increased from said initial value by at least 5 hours.

7. The method according to claim 6, wherein the mammal has an intestinal transit time after absorption, measured by scintigraphy, equal to a value ranging between 20 and 30 hours.

8. The method according to claim 1, wherein the non-averaged daily doses of galactofructose absorbed are less than 5 g.

9. The method according to claim 1, wherein the non-averaged daily doses of galactofructose absorbed are between 0.5 and 2 g for at least 30 consecutive days.

10. (canceled)

11. The method of claim 1, wherein said food composition comprises less than 25% by total weight of sugars selected from the group consisting of such as fructose, epilactose, galactose, and lactose, relative to the amount of said galactofructose.

12. A method for regulating the intestinal transit time of a mammal and for increasing the population of bifidobacteria in the intestinal flora of said mammal in need thereof, said method comprising using a food composition which incorporates galactofructose and which is absorbed by the mammal in an amount corresponding to daily doses of galactofructose, averaged over 30 consecutive days, of between 0.1 and 5 g.

13. The method according to claim 12, wherein regulating the intestinal transit time consists in slowing down intestinal transit in said mammal which it absorbs said food composition.

14. The method according to claim 1, wherein said food composition is in the form of a prepackaged dose comprising from 0.1 to 2 grams of galactofructose.

15. The method according to claim 1, wherein said food composition is manufactured by mixing a galactofructose powder, having a water content of less than 5% by weight, with a foodstuff.

16. The method according to claim 2, wherein the non-averaged daily doses of galactofructose absorbed are less than 5 g.

17. The method according to claim 2, wherein the non-averaged daily doses of galactofructose absorbed are between 0.5 and 2 g for at least 30 consecutive days.

18. The method of claim 2, wherein said food composition comprises less than 25% by total weight of sugars selected from the group consisting of fructose, epilactose, galactose, and lactose, relative to the amount of said galactofructose.

19. The method according to claim 2, wherein said food composition is in the form of a prepackaged dose comprising from 0.1 to 2 grams of said galactofructose.

20. The method according to claim 2, wherein said food composition is manufactured by mixing a galactofructose powder, having a water content of less than 5% by weight, with a foodstuff.

21. The method according to claim 1, wherein the daily doses of said galactofructose, averaged over 30 consecutive days, are between 0.1 and 2 g.

22. The method according to claim 2, wherein the daily doses of said galactofructose, averaged over 30 consecutive days, are between 0.1 and 2 g.

23. The method according to claim 12, wherein the daily doses of said galactofructose, averaged over 30 consecutive days, are between 0.1 and 2 g.
